(19) United States
(12) Patent Application Publication
(10) Pub. No.: US 2018/0012410 A1
(43) Pub. Date: Jan. 11, 2018

(54) DISPLAY CONTROL METHOD AND DEVICE

(71) Applicant: FUJITSU LIMITED, Kawasaki-shi (JP)

(72) Inventor: Susumu Koga, Kawasaki (JP)

(73) Assignee: FUJITSU LIMITED, Kawasaki-shi (JP)

(21) Appl. No.: 15/611,145

(22) Filed: Jun. 1, 2017

(30) Foreign Application Priority Data
Jul. 6, 2016 (JP) 2016-134504

(51) Int. Cl. G06T 19/00; H04N 5/232

(52) U.S. Cl. CPC G06T 19/006; H04N 5/23293

(57) ABSTRACT

A method includes acquiring an image, acquiring display orders of a plurality of object data that respectively correspond to a plurality of reference objects based on correspondence information in which a reference object is associated with an object data that corresponds to the reference object and a display order of the object data, determining, among the plurality of object data, object data that corresponds to a display subject based on the display orders of the plurality of object data, executing a process that generates display information for displaying the object data that is the display subject, controlling a display to display the object data that is the display subject based on an execution result of the process, and performing the executing of the process for another object data, and the controlling of the display based on the another object data, the another object data being a next display subject.

### CROSS-REFERENCE TO RELATED APPLICATION

This application is based upon and claims the benefit of priority of the prior Japanese Patent Application No. 2016-134504, filed on Jul. 6, 2016, the entire contents of which are incorporated herein by reference.

### FIELD

The embodiment discussed herein is related to display control.

### BACKGROUND

In recent years, augmented reality (AR) techniques in which objects are superimposed on a captured image using a display device such as a head mounted display (hereinafter, also referred to as an HMD) have been proposed. A captured image is, for example, captured by an image capturing device provided in an HMD, and is transmitted to a terminal device connected to the HMD. In the terminal device, for example, whether or not there is an AR marker in a continuously acquired, captured image is recognized through an image process. At this time, when a plurality of AR markers are included in a captured image, a recognition process is executed for all of the AR markers in the terminal device.

Japanese Laid-open Patent Publication No. 2010-237393, Japanese National Publication of International Patent Application No. 2013-530462, Japanese Laid-open Patent Publication No. 2014-186434, Japanese Laid-open Patent Publication No. 2011-145879, and Japanese Laid-open Patent Publication No. 2015-146113 are examples of the related art.

### SUMMARY

According to an aspect of the invention, a method includes acquiring an image captured by a camera, acquiring display orders of a plurality of object data that respectively correspond to a plurality of reference objects recognized in the image based on correspondence information in which a reference object is associated with an object data that corresponds to the reference object and a display order of the object data, determining, among the plurality of object data, object data that corresponds to a display subject based on the display orders of the plurality of object data, executing a process that generates display information for displaying the object data that is the display subject, controlling a display to display the object data that is the display subject based on an execution result of the process, and performing the executing of the process for another object data among the plurality of object data, and the controlling of the display based on the another object data, the another object data being a next display subject subsequent to the display subject based on the display orders.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram that illustrates an example of a configuration of a display control system of an embodiment;

FIG. 2 is a diagram that illustrates an example of display in a case in which a plurality of AR markers are included in a captured image;

FIG. 3 is a diagram that illustrates an example of an object data storage unit;

FIG. 4 is a diagram that illustrates an example of the display of object data that corresponds to a plurality of AR markers;

FIG. 5 is a flowchart that illustrates an example of a display control process of an embodiment;

FIG. 6 is a flowchart that illustrates an example of a marker recognition process; and

FIG. 7 is a diagram that illustrates an example of a computer that executes a display control program.

### DESCRIPTION OF EMBODIMENT

When a recognition process is executed on a plurality of AR markers included in a captured image, for example, a processing amount is increased from detecting an AR marker to superimposing AR content, which is an example of object data, in the captured image. Therefore, as a result of executing a recognition process on a plurality of AR markers included in a captured image, power consumption for displaying object data is also increased.

In an aspect, the techniques of the embodiments discussed herein suppress the power consumption arising from the display of object data.

Hereinafter, embodiments of a display control program, a display control method, and a display control device disclosed in the present application will be described in detail with reference to the drawings. Additionally, the techniques of the present disclosure are not limited by the embodiments. In addition, the following embodiments may be combined as appropriate within a non-contradictory range.

### EMBODIMENTS

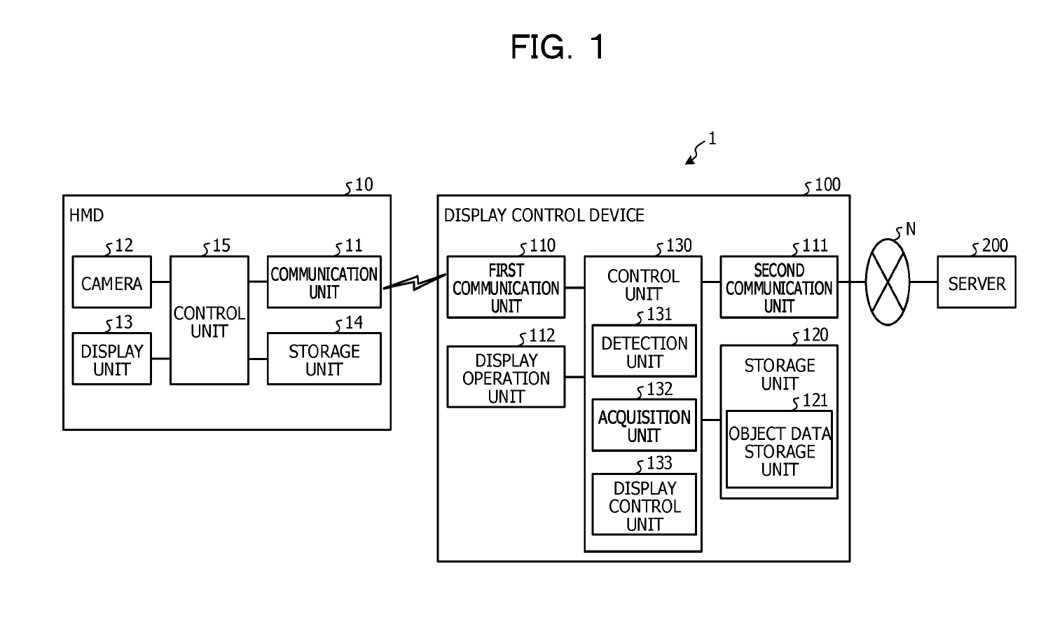

FIG. 1 is a block diagram that illustrates an example of a configuration of a display control system of an embodiment. A display control system 1 illustrated in FIG. 1 includes an HMD 10, a display control device 100, and a server 200. The HMD 10 and the display control device 100 are connected in a wireless manner on a one-to-one basis. That is, the HMD 10 functions as an example of a display unit of the display control device 100. Additionally, in FIG. 1, one set of the HMD 10 and the display control device 100 is illustrated as an example, but the number of display control devices 100 and HMDs 10 is not limited, and there may be an arbitrary number of sets of HMDs 10 and display control devices 100.

For example, the HMD 10 and the display control device 100 are connected in a mutually communicable manner by a wireless local area network (LAN) such as Wi-Fi Direct (registered trademark). In addition, the display control device 100 and the server 200 are connected in a mutually communicable manner by a network N. In the network N, as long as it is possible to adopt an arbitrary type of communication network such as the Internet, a LAN or a virtual private network (VPN), whether or not the connection is wired or wireless is not important.

A user wears the HMD 10 together with the display control device 100, and the HMD 10 displays a display screen transmitted from the display control device 100. For example, the HMD 10 may use a monocular transmissive type HMD. Additionally, for example, the HMD 10 may use various HMDs such as a binocular, or an immersive type. In addition, the HMD 10 includes a camera as an image capturing device, and transmits a captured image captured by the image capturing device to the display control device 100.

The display control device 100 is an information processing device that a user carries and operates, and for example, it is possible to use a mobile communication terminal such as a tablet terminal or a smartphone. The display control device 100 receives a captured image captured by the image capturing device provided in the HMD 10. When a captured image is received, the display control device 100 detects reference objects for superimposing object data in the captured image. The display control device 100 may receive a captured image captured by an image capturing device provided in the display control device 100. In addition, the display control device 100 stores object data and a display order of the object data in a storage unit in association with a reference object. When it is detected that a plurality of reference objects are included in a captured image, the display control device 100 acquires object data and a display orders respectively associated with the plurality of reference objects by referring to the storage unit. The display control device 100 displays the acquired object data in order on a display unit in the acquired display order. In other words, the display control device 100 displays acquired object data by transmitting a display screen on which the acquired object data is superimposed in the acquired display orders to the HMD 10. Additionally, the display control device 100 may display a display screen on which acquired object data is superimposed in the acquired display orders on a display unit of the display control device 100. As a result of this, the display control device 100 may suppress power consumption arising from the display of object data.

For example, the server 200 includes a database that manages AR content for equipment inspection in a certain factory as object data. The server 200 transmits object data to the display control device 100 via the network N in accordance with requests of the display control device 100.

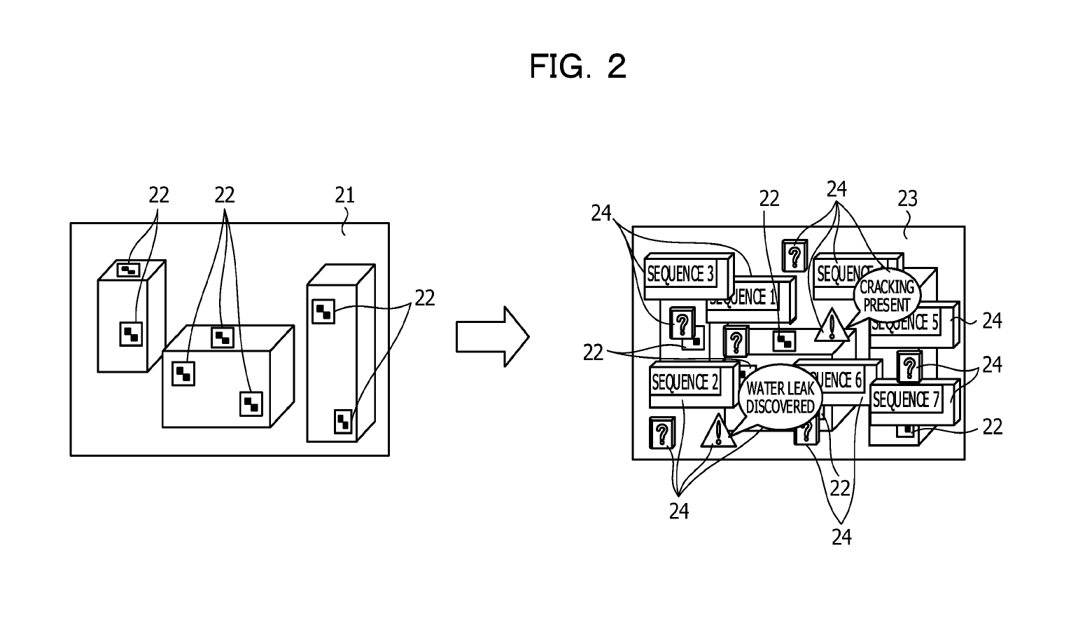

In this instance, a display in a case in which a plurality of AR markers are included in a captured image will be described using FIG. 2. FIG. 2 is a diagram that illustrates an example of display in a case in which a plurality of AR markers are included in a captured image. A plurality of AR markers 22 are included in a captured image 21 of FIG. 2. In this case, in the display of object data (AR content) of the related art, as illustrated in a display screen 23, since a plurality of items of object data 24 are respectively superimposed for the plurality of AR markers 22, the processing amount and processing time in a recognition process of the AR markers 22 is increased. In addition, in the display of object data 24 of the related art, as illustrated in the display screen 23, there are cases in which the plurality of items of object data 24 overlap and the visibility thereof is decreased. In the embodiments discussed herein, a decrease in the processing amount and processing time of a recognition process of AR markers, and an improvement in visibility is achieved by displaying object data in a display order determined in advance.

Next, a configuration of the HMD 10 will be described. As illustrated in FIG. 1, the HMD 10 includes a communication unit 11, a camera 12, a display unit 13, a storage unit 14, and a control unit 15. Furthermore, in addition to the functional units illustrated in FIG. 1, for example, the HMD 10 may also be configured to have functional units such as various input devices and audio output devices.

For example, the communication unit 11 is realized by a communication module, or the like, such as a wireless LAN. For example, the communication unit 11 is a communication interface that is wirelessly connected to the display control device 100 by using Wi-Fi Direct (registered trademark), and manages the communication of information with the display control device 100. The communication unit 11 receives a display screen from the display control device 100. The communication unit 11 outputs the received display screen to the control unit 15. In addition, the communication unit 11 transmits a captured image input from the control unit 15 to the display control device 100.

The camera 12 is an image capturing device that captures an image of reference objects that are associated with AR content, which is an example of object data, or in other words, AR markers. Additionally, in the following description, there are cases in which reference objects are referred to as AR markers, or merely markers. In addition, there are cases in which object data is referred to as AR content. For example, the camera 12 captures an image using a complementary metal oxide semiconductor (CMOS) image sensor, a charge coupled device (CCD) image sensor, or the like, as an image capturing element. The camera 12 creates a captured image by performing analog/digital (A/D) conversion by photoelectrically converting light that the image capturing element receives. The camera 12 outputs the created captured image to the control unit 15.

The display unit 13 is a display device for displaying various information. For example, the display unit 13 corresponds to a display element of a transmissive type HMD in which a picture is projected onto a half mirror and it is possible for a user to see through external scenery and the picture. Additionally, the display unit 13 may be a display element that corresponds to an HMD such as an immersive type, a video transmissive type, or a retina projection type.

For example, the storage unit 14 is realized by a storage device such as random access memory (RAM), or a semiconductor memory element such as flash memory. The storage unit 14 stores information used in processing by the control unit 15.

For example, the control unit 15 is realized as a result of a program stored inside a storage device being executed by a central processing unit (CPU) or a micro processing unit (MPU), using the RAM as a work region. In addition, for example, the control unit 15 may be configured to be realized by an integrated circuit such as an application specific integrated circuit (ASIC) or a field programmable gate array (FPGA). The control unit 15 realizes or executes the functions and actions of information processing that is described hereinafter.

When a captured image captured by the camera 12 is input, the control unit 15 transmits the input captured image to the display control device 100 via the communication unit 11. Additionally, when a captured image is sequentially input from the camera 12, the control unit 15 continuously performs transmission of the captured image to the display control device 100. In addition, the control unit 15 displays a display screen received from the display control device 100 via the communication unit 11 on the display unit 13.

Next, a configuration of the display control device 100 will be described. As illustrated in FIG. 1, the display control device 100 includes a first communication unit 110, a second communication unit 111, a display operation unit 112, a storage unit 120, and a control unit 130. Furthermore, in addition to the functional units illustrated in FIG. 1, for example, the display control device 100 may also be configured to have various known functional units that computers have such as various input devices and audio output devices. For example, the display control device 100 may include an image capturing device, which is not illustrated in the drawings.

For example, the first communication unit 110 is realized by a communication module, or the like, such as a wireless LAN. For example, the first communication unit 110 is a communication interface that is wirelessly connected to the HMD 10 by using Wi-Fi Direct (registered trademark), and manages the communication of information with the HMD 10. The first communication unit 110 receives a captured image from the HMD 10. The first communication unit 110 outputs the received captured image to the control unit 130. In addition, the first communication unit 110 transmits the display screen input from the control unit 130 to the HMD 10.

For example, the second communication unit 111 is realized by a communication module, or the like, such as a portable telephone line, including a third generation mobile communication system or long term evolution (LTE), or the like, or a wireless LAN. The second communication unit 111 is a communication interface that is wirelessly connected to the server 200 via the network N, and manages the communication of information with the server 200. The second communication unit 111 transmits a data acquisition instruction input from the control unit 130 to the server 200 via the network N. In addition, the second communication unit 111 receives object data in accordance with the data acquisition instruction from the server 200 via the network N. The second communication unit 111 outputs the received object data to the control unit 130.

The display operation unit 112 is a display device for displaying various information and an input device that receives various operations from a user. For example, the display operation unit 112 is realized by a liquid crystal display, or the like, as a display device. In addition, for example, the display operation unit 112 is realized by a touch panel, or the like, as an input device. In other words, in the display operation unit 112, a display device and an input device are integrated. The display operation unit 112 outputs an operation input by a user to the control unit 130 as operation information. Additionally, the display operation unit 112 may display a similar screen to that of the HMD 10, or may display a different screen to that of the HMD 10.

For example, the storage unit 120 is realized by a storage device such as RAM, a semiconductor memory element such as flash memory, a hard disk, or an optical disc. The storage unit 120 includes an object data storage unit 121. In addition, the storage unit 120 stores information used in processing by the control unit 130.

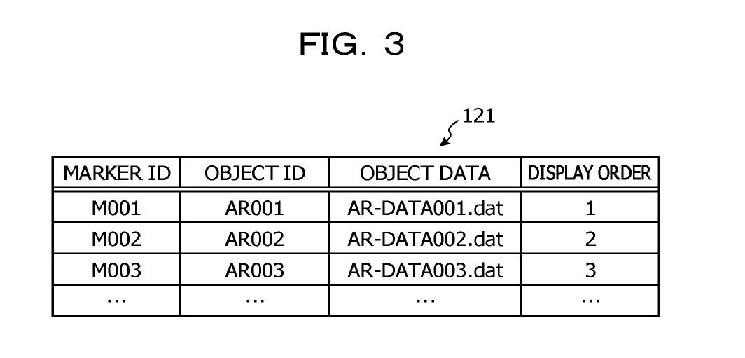

The object data storage unit 121 stores object data acquired from the server 200. FIG. 3 is a diagram that illustrates an example of an object data storage unit. As illustrated in FIG. 3, the object data storage unit 121 includes entries for “Marker Identifier (ID)”, “Object ID”, “Object Data”, and “Display Order”. For example, the object data storage unit 121 stores each item of object data as one record.

The “Marker ID” is an identifier that identifies an AR marker associated with object data. The “Object ID” is an identifier that identifies object data, or in other words, an item of AR content. The “Object Data” is information that indicates object data acquired from the server 200. For example, the “Object Data” is a data file that constitutes object data, or in other words, AR content. The “Display Order” is information that indicates a display order associated with object data. For example, the “Display Order” is information for determining a display order of object data associated with AR markers in a captured image in a case in which there are a plurality of AR markers in the captured image.

For example, the control unit 130 is realized as a result of a program stored inside a storage device being executed by a CPU, an MPU, or the like, using the RAM as a work region. In addition, for example, the control unit 130 may be configured to be realized by an integrated circuit such as an ASIC or an FPGA. The control unit 130 includes a detection unit 131, an acquisition unit 132, and a display control unit 133, and realizes or executes functions and actions of information processing described hereinafter. Additionally, the internal configuration of the control unit 130 is not limited to the configuration illustrated in FIG. 1, and may be any other configuration as long as it is a configuration that performs the information processing that will be mentioned later.

The detection unit 131 performs acquisition by receiving a captured image from the HMD 10 via the first communication unit 110. Additionally, the detection unit 131 may acquire a captured image from an image capturing device of the display control device 100, which is not illustrated in the drawings. The detection unit 131 executes rectangle extraction and ID detection of AR markers from the acquired captured image. That is, firstly, the detection unit 131 extracts a rectangle of an AR marker from the captured image. Subsequently, the detection unit 131 detects a marker ID from the extracted rectangle. When a marker ID is detected, the detection unit 131 outputs the detected marker ID to the acquisition unit 132. Additionally, the detection unit 131 outputs a plurality of marker IDs to the acquisition unit 132 in a case in which a plurality of marker IDs are detected from the captured image. In addition, the detection unit 131 outputs the captured image to the display control unit 133.

When a marker ID is input from the detection unit 131, the acquisition unit 132 acquires object data associated with the marker ID and a display order of the object data by referring to the object data storage unit 121. In other words, when it is detected that a plurality of reference objects are included in a captured image captured by an image capturing device, the acquisition unit 132 refers to the object data storage unit 121, which stores object data and the display orders of the object data in association with reference objects. The acquisition unit 132 acquires object data and display orders respectively associated with a plurality of reference objects by referring to the object data storage unit 121. The acquisition unit 132 outputs a marker ID, object data, and a display order to the display control unit 133.

The display control unit 133 activates an application used in AR middleware. When the application is activated, the display control unit 133 starts the transmission of a display screen of the application to the HMD 10 via the first communication unit 110. Additionally, the display control unit 133 may also display a display screen of the application on the display operation unit 112.

Subsequently, the display control unit 133 transmits a data acquisition instruction to the server 200 via the second communication unit 111 and the network N. When acquisition is performed by receiving object data that corresponds to the data acquisition instruction from the server 200 via the second communication unit 111 and the network N, the display control unit 133 stores the acquired object data in the object data storage unit 121. Additionally, for example, the received item of object data includes the entries for “Object ID”, “Object Data”, and “Display Order” illustrated in FIG. 3.

When a marker ID, object data, and a display order are input from the acquisition unit 132, the display control unit 133 determines whether or not this is an initial recognition, or in other words, whether or not a captured image has transitioned to a recognized state of AR markers from an unrecognized state. In a case in which this is an initial recognition, the display control unit 133 sets a marker ID of object data of a display subject based on the display order. That is, in a case in which a plurality of marker IDs, items of object data, and display orders are input, the display control unit 133 sets a marker ID having the lowest display order as a marker ID of object data of a display subject. Additionally, a case in which this is not an initial recognition is a state in which all of the marker IDs of object data of a display subject are set. That is, if any of the AR markers have been recognized, the display control unit 133 maintains the marker ID that corresponds to the object data being displayed. In addition, the display control unit 133 resets setting of the marker IDs in a case in which none of the AR markers are still included in a captured image.

The display control unit 133 determines whether or not an input marker ID, or in other words, object data that corresponds to a marker ID detected from a captured image is a display subject. That is, in a case in which a plurality of marker IDs are input, the display control unit 133 determines whether or not object data that corresponds to any one of the marker IDs is a display subject. In a case in which object data that corresponds to a detected marker ID is a display subject, the display control unit 133 calculates transfer and rotation matrices for the AR marker of the marker ID of the captured image input from the detection unit 131.

In a case in which object data that corresponds to a detected marker ID is not a display subject, the display control unit 133 does not calculate transfer and rotation matrices for the AR marker of the marker ID of the captured image input from the detection unit 131. That is, among a plurality of AR markers included in a captured image, the display control unit 133 calculates transfer and rotation matrices for an AR marker that corresponds to object data of a display subject, and does not calculate transfer and rotation matrices for AR markers that correspond to object data that is not the display subject.

In other words, regarding object data that is displayed in order, the display control unit 133 only calculates information related to the display of object data for object data of a display subject. Additionally, the information related to the display of object data is a vector that indicates an axis of a reference object. That is, the information related to the display of object data is transfer and rotation matrices that indicate the extent of the inclination and the extent of the size of an AR marker.

The display control unit 133 creates a display screen by superimposing object data of a display subject on a captured image. The display control unit 133 displays the object data by transmitting the created display screen to the HMD 10 via the first communication unit 110. In other words, in a case in which a plurality of AR markers are included in a captured image, the display control unit 133 creates a display screen by superimposing object data that respectively corresponds to the AR markers on the captured image in a sequence of the display orders, and displays the object data by transmitting the created display screen to the HMD 10. Additionally, the display control unit 133 may display a created display screen on the display operation unit 112. In addition, in a case in which the display order has reached the end, the display control unit 133 returns to the beginning and repeatedly displays the object data in accordance with the display orders.

The display control unit 133 determines whether or not there is an operation that selects object data from a user. Additionally, for example, an selection operation may be input from the display operation unit 112, or may be input by voice by using a microphone, which is not illustrated in the drawings. In a case in which there is a selection operation, the display control unit 133 performs setting so as to fix the marker ID that corresponds to selected object data as a display subject. Additionally, the display control unit 133 may be configured to make a display time of a selected item of object data longer than that of object data that is not selected. In other words, among object data displayed on the display unit 13 of the HMD 10, the display control unit 133 makes a display time of object data for which selection is received longer in a case in which selection of any one of the items of object data is received than in a case in which selection is not received.

In addition, among object data displayed on the display unit 13 of the HMD 10, the display control unit 133 may be configured to make a display time of object data related to an alarm longer than a display time of other object data. Furthermore, the display control unit 133 may be configured to prioritize object data related to an alarm in the display order. In addition, the display control unit 133 may set the display order as the editing date order of object data.

In a case in which there is not a selection operation, the display control unit 133 performs setting by changing the marker IDs in accordance with the display order. For example, if the previously set marker ID is display order No. “1”, the display control unit 133 performs setting by changing to a marker ID that corresponds to object data of display order No. “2”.

The display control unit 133 determines whether or not there is an operation that cancels the setting that fixes a marker ID. In a case in which there is a cancellation operation, the display control unit 133 cancels the setting that fixes a marker ID. In a case in which there is not a cancellation operation, the display control unit 133 does not change the fixed marker ID as it is in a case in which there is a fixed marker ID.

For example, the display control unit 133 determines whether or not the application is terminated as a result of an operation from a user. In a case in which an application is terminated, the display control unit 133 notifies each unit of the display control device 100 and the HMD 10 of the termination of the application. In a case in which the application is not terminated, the display control unit 133 continues recognition of AR markers and superimposing object data.

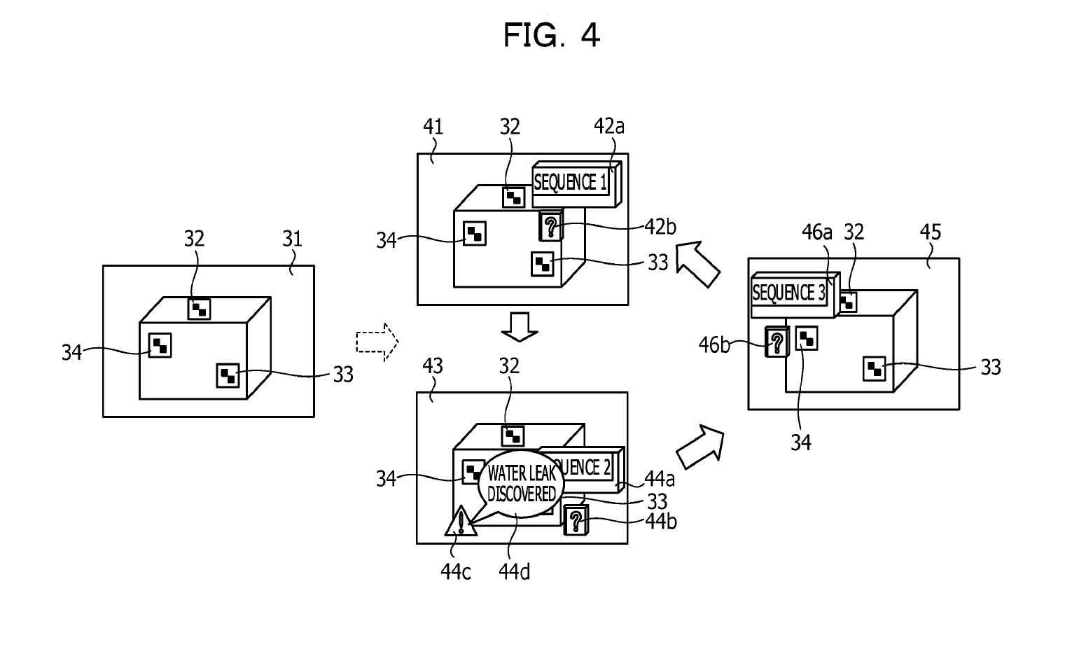

In this instance, the display of object data that corresponds to a plurality of AR markers will be described using FIG. 4. FIG. 4 is a diagram that illustrates an example of the display of object data that corresponds to a plurality of AR markers. As illustrated in FIG. 4, a plurality of AR markers 32, 33, and 34 are included in a captured image 31. In addition, in the display orders, the AR marker 32 is No. “1”, the AR marker 33 is No. “2”, and the AR marker 34 is No. “3”. At this time, as illustrated in a display screen 41, firstly, the display control device 100 displays items of object data 42a and 42b that correspond to the AR marker 32, the display order of which is No. “1”. Additionally, the object data that corresponds to the AR markers 33 and 34 is not displayed on the display screen 41.

Next, as illustrated in a display screen 43, the display control device 100 displays items of object data 44a, 44b, 44c, and 44d that correspond to the AR marker 33, the display order of which is No. “2”. Additionally, the object data that corresponds to the AR markers 32 and 34 is not displayed on the display screen 43.

Subsequently, as illustrated in a display screen 45, the display control device 100 displays items of object data 46a and 46b that correspond to the AR marker 34, the display order of which is No. “3”. Additionally, the object data that corresponds to the AR markers 32 and 33 is not displayed on the display screen 45. The display control device 100 switches between the display screens 41, 43, and 45 in order at a predetermined time interval. Additionally, for example, it is possible to set the predetermined time interval to 5 to 30 frames/second, that is, 33 ms to 200 ms to match the frame rate of a moving image of a captured image. In addition, for example, the predetermined time interval may be set to be a time interval such as a 1 second interval so that recognition by a user is possible.

In addition, in a case in which the number of recognized AR markers is increased midway through, the display control device 100 adds a marker ID of an increased AR marker to the display order. For example, it is assumed that recognized marker IDs are “M001”, “M002”, and “M003”, and that the marker ID of object data being displayed in increasing display order number sequence is “M002”. At this time, when a marker ID “M004” of a new AR marker is recognized, the “M004” is added to the end of the display order. In addition, the display of object data that corresponds to the marker ID “M002”, which is being displayed, is continued without change for an initial display time, and thereafter, the display switches to object data that corresponds to the marker IDs “M003” and “M004”.

Furthermore, in a case in which the number of recognized AR markers is decreased midway through, the display control device 100 deletes a marker ID of a decreased AR marker from the display order. In the above-mentioned example, for example, if it is no longer possible to recognize the AR marker of the marker ID “M002” due to the occurrence of noise or a change in the direction of the camera 12, the display control device 100 changes the object data being displayed from the marker ID “M002” to object data that corresponds to “M003”. In addition, the display control device 100 deletes the “M002” from the display order, and sets the display orders of “M001” and “M003”. As a result of this, it is possible for the display control device 100 to suppress resetting of a display process of object data. That is, since the display control device 100 does not reset the display order in accordance with recognized marker IDs being frequently altered, it is possible to suppress the display frequency from decreasing for object data that is later in the display order.

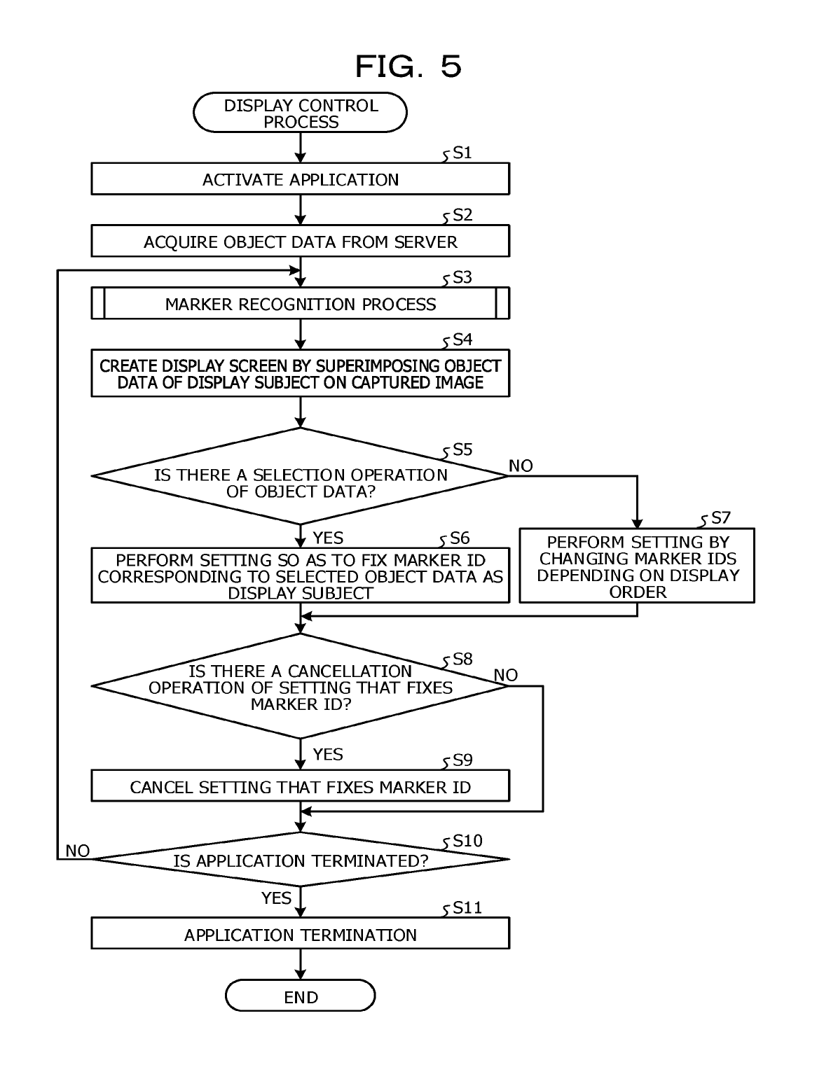

Next, actions of the display control system 1 of the embodiment will be described. FIG. 5 is a flowchart that illustrates an example of a display control process of the embodiment.

The display control unit 133 of the display control device 100 activates an application used in AR middleware (step S1). When the application is activated, the display control unit 133 starts the transmission of a display screen of the application to the HMD 10.

The display control unit 133 transmits a data acquisition instruction to the server 200. When acquisition is performed by receiving object data that corresponds to the data acquisition instruction from the server 200, the display control unit 133 stores the acquired object data in the object data storage unit 121 (step S2).

The HMD 10 starts the transmission of a captured image captured by the camera 12 to the display control device 100. In addition, the display control device 100 starts the transmission of a display screen including a captured image to the HMD 10.

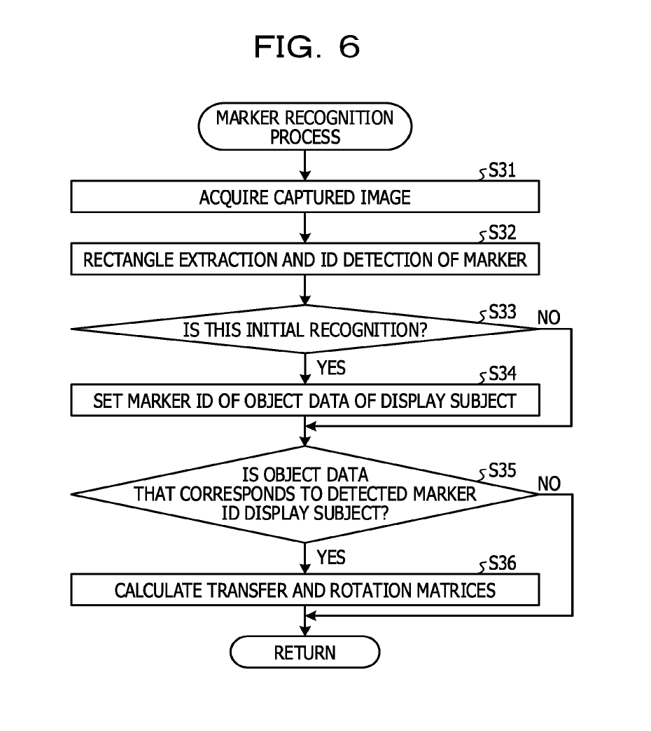

The display control device 100 executes a marker recognition process (step S3). In this instance, the marker recognition process will be described using FIG. 6. FIG. 6 is a flowchart that illustrates an example of a marker recognition process.

The detection unit 131 of the display control device 100 performs acquisition by receiving a captured image from the HMD 10 (step S31). The detection unit 131 executes rectangle extraction and ID detection of AR markers from an acquired captured image (step S32). When a marker ID is detected, the detection unit 131 outputs the detected marker ID to the acquisition unit 132. In addition, the detection unit 131 outputs a captured image to the display control unit 133.

When a marker ID is input from the detection unit 131, the acquisition unit 132 acquires object data associated with the marker ID and a display order of the item of object data by referring to the object data storage unit 121. The acquisition unit 132 outputs a marker ID, object data, and a display order to the display control unit 133.

When a marker ID, object data, and a display order are input from the acquisition unit 132, the display control unit 133 determines whether or not this is an initial recognition (step S33). In a case in which this is an initial recognition (step S33: Yes), the display control unit 133 sets a marker ID of object data of a display subject based on the display order (step S34), and the process proceeds to step S35. In a case in which this is not an initial recognition (step S33: No), the display control unit 133 retains already set marker IDs, and the process proceeds to step S35.

The display control unit 133 determines whether or not object data that corresponds to a marker ID detected from a captured image is a display subject (step S35). In a case in which object data that corresponds to a detected marker ID is a display subject (step S35: Yes), the display control unit 133 calculates transfer and rotation matrices for the AR marker of the marker ID (step S36), and returns to the original process. In a case in which object data that corresponds to a detected marker ID is not a display subject (step S35: No), the display control unit 133 returns to the original process without calculating transfer and rotation matrices for the AR marker of the marker ID. Additionally, the determination of step S35 is performed for each of the AR markers included in a captured image.

Returning to the description of FIG. 5, the display control unit 133 creates a display screen by superimposing object data of a display subject on a captured image (step S4). The display control unit 133 displays by transmitting the created display screen to the HMD 10.

The display control unit 133 determines whether or not there is an operation that selects object data from a user (step S5). In a case in which there is a selection operation (step S5: Yes), the display control unit 133 performs setting so as to fix the marker ID that corresponds to selected object data as a display subject (step S6). In a case in which there is not a selection operation (step S5: No), the display control unit 133 performs setting by changing the marker IDs in accordance with the display order (step S7).

The display control unit 133 determines whether or not there is an operation that cancels the setting that fixes a marker ID (step S8). In a case in which there is a cancellation operation (step S8: Yes), the display control unit 133 cancels the setting that fixes a marker ID (step S9), and the process proceeds to step S10. In a case in which there is not a cancellation operation (step S8: No), the display control unit 133 maintains the fixed marker ID as it is in a case in which there is a fixed marker ID, and the process proceeds to step S10.

The display control unit 133 determines whether or not the application is terminated as a result of an operation from a user (step S10). In a case in which the application is not terminated (step S10: No), the display control unit 133 returns to step S3. In a case in which the application is terminated (step S10: Yes), the display control unit 133 terminates the application (step S11), and terminates the display control process. In this manner, since the display control device 100 only performs processes (example: calculation of transfer and rotation matrices) desired for display for object data set as a display subject, it is possible to suppress power consumption arising from the display of object data. More specifically, in display control of the related art illustrated in FIG. 2, since object data associated with all detected markers is set as a display subject, a calculation process of transfer and rotation matrices is executed for all object data. Furthermore, there are also cases in which this leads to a decrease in the visibility of a user as a result of object data associated with all detected markers being displayed in the manner of FIG. 2. In such an instance, the display control device 100 according to the present embodiment specifies object data that corresponds to a display subject by altering the object data storage unit to a data configuration that includes data that indicates the display order of object data. Further, as a result of only calculating transfer and rotation matrices for object data of a display subject, in comparison with display control of the related art, it is possible to decrease the processing amount and suppress decreases in the visibility of a user in a superimposed image.

Additionally, the above-mentioned embodiment displayed a display screen on the display unit 13 of the HMD 10 based on a captured image captured by the camera 12 of the HMD 10, but is not limited to this configuration. For example, an image capturing device may be provided in the display control device 100, and a display screen may be displayed on the display operation unit 112 based on a captured image captured by the image capturing device. That is, a display control process may be exclusively performed in the display control device 100.

In other words, the above-mentioned embodiment described an aspect in which a user wears the display control device 100 and the HMD 10, but is not limited to this configuration. For example, a configuration in which the HMD 10 is not used and a display screen is displayed on the display operation unit 112 of the display control device 100, which is a smartphone, for example, may also be used.

In this manner, the display control device 100 detects that a plurality of reference objects are included in a captured image captured by the camera 12, which is an image capturing device of the HMD 10. In addition, the display control device 100 stores object data and a display order of the object data in the object data storage unit 121 in association with a reference object. In addition, when it is detected that a plurality of reference objects are included in a captured image, the display control device 100 acquires object data and a display orders respectively associated with the plurality of reference objects by referring to the object data storage unit 121. In addition, the display control device 100 displays acquired object data in order on the display unit 13 of the HMD 10 in acquired display orders. As a result of this, it is possible to suppress power consumption arising from the display of object data.

In addition, among object data displayed on the display unit 13, the display control device 100 makes a display time of object data for which selection is received longer in a case in which selection of any one of the items of object data is received than in a case in which selection is not received. As a result of this, it is possible to continue a display state of content that a user is focusing on.

In addition, among object data displayed on the display unit 13, the display control device 100 makes a display time of object data related to an alarm longer than a display time of other object data. As a result of this, it easier to transmit information related to an alarm to a user.

In addition, the display control device 100 prioritizes object data related to an alarm in the display order. As a result of this, it easier to transmit information related to an alarm to a user.

In addition, in the display control device 100, the display order is the editing date order of object data. As a result of this, it is possible to display object data in editing order.

In addition, regarding object data that is displayed in order, the display control device 100 only calculates information related to the display of object data for object data of a display subject. As a result of this, it is possible to suppress power consumption arising from the display of object data.

In addition, in the display control device 100, the information related to the display of object data is a vector that indicates an axis of a reference object. As a result of this, since it is possible to suppress the calculation of vectors, it is possible to suppress power consumption arising from the display of object data.

Additionally, the above-mentioned embodiment sets the display order as an increasing number sequence, but is not limited to this configuration. For example, the display order may be a decreasing number sequence, or may be an order set in advance by a user.

In addition, each constituent element of each unit illustrated is not necessarily physically configured in the manner illustrated. That is, the specific forms of the distribution and integration of each unit are not limited to the illustrated aspects, and all or a portion thereof may be distributed and integrated in arbitrary units in either a functional or physical manner depending on various loads, usage states, and the like. For example, the detection unit 131 and the acquisition unit 132 may be integrated. In addition, each process illustrated is not limited to the above-mentioned order, and in a range that does not contradict the process contents, may be implemented simultaneously, or may be implemented by replacing the order thereof.

Furthermore, all or an arbitrary portion of the various processing functions that are performed by each device may be configured to be executed in a CPU (or in a microcomputer such as an MPU or a micro controller unit (MCU)). In addition, naturally, all or an arbitrary portion of the various processing functions may be configured to be executed in a program that is analyzed and executed by a CPU (or a microcomputer such as an MPU or MCU), or in hardware by using wired logic.

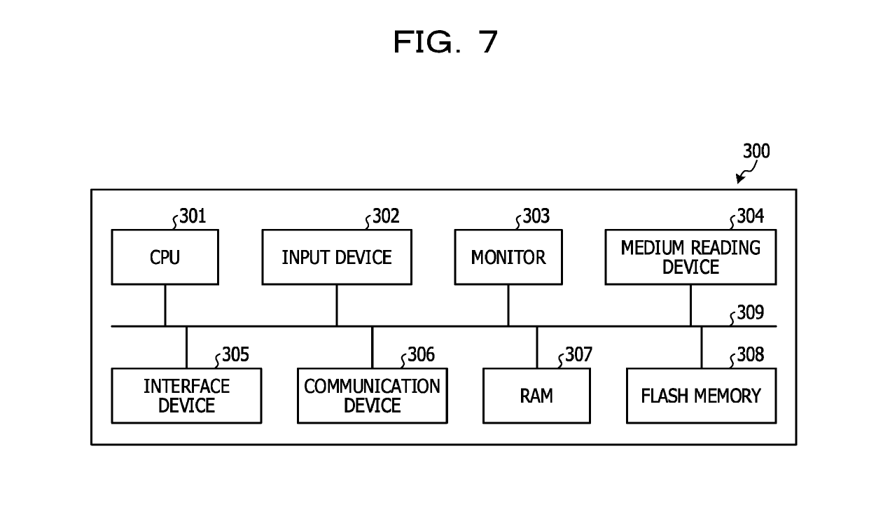

However, the various processes described in the above-mentioned embodiment may be realized by executing a program prepared in advance on a computer. In such an instance, hereinafter, an example of a computer that executes a program having functions similar to those of the above-mentioned embodiment will be described. FIG. 7 is a diagram that illustrates an example of a computer that executes a display control program.

As illustrated in FIG. 7, a computer 300 includes a CPU 301 that executes various arithmetic processes, an input device 302 that receives data input, and a monitor 303. In addition, the computer 300 includes a medium reading device 304 that reads a program, or the like, from a storage medium, an interface device 305 for connecting to various devices, and a communication device 306 for connecting to other information processing devices, or the like, in a wired or wireless manner. In addition, the computer 300 includes a RAM 307 that temporarily stores various information, and a flash memory 308. In addition, each device 301 to 308 is connected to a bus 309.

A display control program that has functions similar to those of each processing unit of the detection unit 131, the acquisition unit 132, and the display control unit 133 illustrated in FIG. 1 is stored in the flash memory 308. In addition, various data for realizing the object data storage unit 121 and the display control program is stored in the flash memory 308. For example, the input device 302 receives the input of various information such as operation information from a user of the computer 300. For example, the monitor 303 displays various screens such as a display screen to a user of the computer 300. For example, the interface device 305 is connected to headphones, or the like. For example, the communication device 306 has functions similar to those of the first communication unit 110 and the second communication unit 111 illustrated in FIG. 1, is connected to the HMD 10 and the network N, and exchanges various information with the HMD 10 and the server 200.

The CPU 301 reads each program stored in the flash memory 308, and performs various processes as a result of executing the programs through development in the RAM 307. In addition, these programs may cause the computer 300 to function as the detection unit 131, the acquisition unit 132, and the display control unit 133 illustrated in FIG. 1.

Additionally, the above-mentioned display control program is not necessarily stored in the flash memory 308. For example, a configuration in which the computer 300 reads and executes programs stored on a storage medium that is readable by the computer 300, may also be used. For example, a storage medium that is readable by the computer 300 corresponds to a portable recording medium such as a CD-ROM, a DVD disk, or a Universal Serial Bus (USB), semiconductor memory such as flash memory, a hard disk drive, or the like. In addition, the display control program may be stored on devices connected to a public line, the Internet, a LAN, or the like, and the computer 300 may read and execute the display control program from these devices.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A method executed by a computer, the method comprising:
acquiring an image captured by a camera;
acquiring display orders of a plurality of object data that respectively correspond to a plurality of reference objects recognized in the image based on correspondence information in which a reference object is associated with an object data that corresponds to the reference object and a display order of the object data;
determining, among the plurality of object data, object data that corresponds to a display subject based on the display orders of the plurality of object data;
executing a process that generates display information for displaying the object data that is the display subject;
controlling a display to display the object data that is the display subject based on an execution result of the process; and
performing the executing of the process for another object data among the plurality of object data, and the controlling of the display based on the another object data, the another object data being a next display subject subsequent to the display subject based on the display orders.

2. The method according to claim 1, wherein the process includes:
calculating a vector that indicates an axis of a specific reference object with which the object data that is the display subject is associated, and
determining a display position of the object data that is the display subject on the display based on the vector.

3. The method according to claim 2, wherein the vector is expressed by a transfer matrix and a rotation matrix of the specific reference object in a coordinate system defined by an photographing position and an photographing orientation of the camera.

4. A method executed by a computer, the method comprising:
acquiring a plurality of object data that are respectively associated with a plurality of reference objects detected in an image captured by a camera, and respective display orders of the plurality of object data, based on correspondence information in which object data, a display order of the object data, and a reference object that corresponds to the object data are associated; and
respectively displaying the plurality of object data on a display in order based on the display order.

5. The method according to claim 4, further comprising:
setting a display time of specific object data, among a portion of object data displayed on the display, to be longer in a case in which selection of the specific object data is received than in a case in which the selection is not received.

6. The method according to claim 4, further comprising:
setting a display time of object data related to an alarm to be longer than a display time of another object data.

7. The method according to claim 4, wherein the display order of object data related to an alarm is set to have priority.

8. The method according to claim 4, wherein the display order is set according to an editing date and time order of the object data.

9. The method according to claim 4, wherein the displaying includes calculating display information only for the object data that is a display subject determined based on the display order.

10. The method according to claim 4, wherein the display information is a vector that indicates an axis of the reference object.

11. A device comprising:
a memory; and
a processor coupled to the memory and configured to:
acquire an image captured by a camera,
acquire display orders of a plurality of object data that respectively correspond to a plurality of reference objects recognized in the image based on correspondence information in which a reference object is associated with an object data that corresponds to the reference object and a display order of the object data,
determine, among the plurality of object data, object data that corresponds to a display subject based on the display orders of the plurality of object data,
execute a process that generates display information for displaying the object data that is the display subject,
control a display to display the object data that is the display subject based on an execution result of the process, and
perform a execution of the process for another object data among the plurality of object data, and a control of the display based on the another object data, the another object data being a next display subject subsequent to the display subject based on the display orders.

12. The device according to claim 11, wherein the process includes:
calculating a vector that indicates an axis of a specific reference object with which the object data that is the display subject is associated, and
determining a display position of the object data that is the display subject on the display based on the vector.

13. The device according to claim 12, wherein the vector is expressed by a transfer matrix and a rotation matrix of the specific reference object in a coordinate system defined by an photographing position and an photographing orientation of the camera.
